(19) United States
(12) Patent Application Publication
(10) Pub. No.: US 2020/0409319 A1
(43) Pub. Date: Dec. 31, 2020

(54) MULTI-PERIOD TRANSACTIVE COORDINATION FOR DAY-AHEAD ENERGY AND ANCILLARY SERVICE MARKET CO-OPTIMIZATION WITH DER FLEXIBILITIES AND UNCERTAINTIES

(71) Applicant: Battelle Memorial Institute, Richland, WA (US)

(72) Inventors: Ke Ma, Richland, WA (US); Jianming Lian, Richland, WA (US)

(73) Assignee: Battelle Memorial Institute, Richland, WA (US)

(21) Appl. No.: 16/912,442

(22) Filed: Jun. 25, 2020

Related U.S. Application Data
(60) Provisional application No. 62/866,443, filed on Jun. 25, 2019.

(51) Int. Cl. G05B 13/04; H02J 13/00; G06Q 50/06; G06Q 40/04

(52) U.S. Cl. CPC G05B 13/041; G06Q 40/04; G06Q 50/06; H02J 13/00002

(57) ABSTRACT

Methods include iterating a price vector between a coordinator and a plurality of participants, wherein the price vector comprises prices for energy services and ancillary services to be produced or consumed by the participants during a plurality of time periods that form power transmission time sequence of power transmission over a power transmission network, until a convergent price vector is obtained, and responsive to the convergent price vector, producing or consuming power over the power transmission network and providing ancillary services to the power transmission network during at least one of the time periods of the power transmission time sequence. Related apparatus are also disclosed.

### CROSS REFERENCE TO RELATED APPLICATION

This application claims priority to U.S. Provisional Patent Application No. 62/866,443, filed Jun. 25, 2019, which is incorporated herein by reference in its entirety.

### ACKNOWLEDGMENT OF GOVERNMENT SUPPORT

This invention was made with government support under Contract DE-AC0576RL01830 awarded by the U.S. Department of Energy. The government has certain rights in the invention.

### FIELD

The field is energy transmission.

### BACKGROUND

Power transmission of various scales, from large power grids to smaller units such as campuses or even households, generally encounter difficulties in trying deliver energy efficiently while meeting ancillary service requirements and ensuring balance between supply and demand. Further difficulties arise when attempting to gauge power supply and demand and ancillary capabilities so that power can be supplied efficiently among participants while preserving privacy of the participant's characteristics. Thus, a need remains for improved power transmission methods and systems.

### SUMMARY

Apparatus and methods are disclosed that can provide iterative multi-period transactive coordination for energy and ancillary services in various settings. Various examples can account for DER flexibilities and uncertainties, and can provide market clearing price vectors even while preserving participant privacy.

According to an aspect of the disclosed technology, example methods of producing or consuming power by a participant coupled to a power transmission network by establishing a price vector with a coordinator, include estimating energy and ancillary services that the participant can produce for or consume from the power transmission network for each time period in a power transmission time sequence at prices of an iteration k price vector based on the iteration k price vector and states, utilities, and dynamics of the participant and sending the estimates to the coordinator. Some examples further include, responsive to sending the estimates, receiving an updated price vector from the coordinator for a subsequent iteration k+1, wherein the updated price vector is produced based on the estimates sent to the coordinator and estimates received by the coordinator from each other participant coupled to the power transmission network. Some examples further include iterating the estimating, sending, and receiving until the price vector becomes a convergent price vector such that for each time period of the power transmission time sequence the combined energy for all participants is balanced and the ancillary services satisfy power transmission network requirements. In some examples, the estimating energy and ancillary services for one of the time periods is based on the iteration k price vector and states, utilities, and dynamics of the participant includes selecting energy and ancillary service values from a participant iteration function. In some examples, the participant iteration function compares (i) a utility function specific to the participant, (ii) the energy amount produced for or consumed from the transmission network by the participant as constrained by a coupling of the participant to the power transmission network, and (iii) the ancillary services provided to the power transmission network by the participant, and that is subject to state, energy, and ancillary service constraints of the participant at a subsequent time period. In some examples, the estimating energy and ancillary services for each of the time periods in the power transmission time sequence corresponds to constructing a price horizon extending from a selected one of the time periods of the power transmission time sequence by the number of periods in the power transmission time sequence, wherein the constructing includes selecting energy and ancillary service expected values for each time period of the price horizon from a participant iteration function. In some examples, the participant iteration function compares (i) a quadratic utility function associated with a utility function specific to the participant, (ii) the energy amount produced for or consumed from the transmission network as constrained by a coupling of the participant to the power transmission network, and (iii) the ancillary services provided to the transmission network by the participant, and that is subject to stochastic characteristics of the participant. Some examples further include iterating the estimating, sending, and receiving until the price vector associated with the price horizon becomes convergent, iterating the estimating, sending, and receiving to construct price horizons extending from each of the other time periods of the power transmission time sequence, and using the convergent energy and ancillary service expected values associated with the first time period of each of the price horizons that have become convergent to form the convergent price vector. In some examples, coupling of the participant to the power transmission network is described by a mapping of power injection into or received from the power transmission network at buses onto active power flow on branches of the power transmission network. In some examples, an updated price vector comprises the iteration k price vector modified by a subgradient value associated with the estimates and with an updated convergence parameter. In some examples, energy and ancillary services are estimated simultaneously in relation to each other using a utility function specific to the participant and power transmission constraints of the power transmission network. In some examples, energy services and ancillary services are hierarchically decentralized between the coordinator, the participant, and other participants in communication with the coordinator. In some examples, the coordinator and participants include an independent system operator (ISO) and load serving entities (LSE), a distribution system operator (DSO) and distributed generators, a campus control center and campus buildings, a local grid controller and building customers, or a residential building and internal loads. In some examples, a convergent price vector is obtained by the iterating in the absence of information by the coordinator of participant specific states, utilities, and/or dynamics and in the absence of information by each participant of specific states, utilities, and/or dynamics of each other participant. Some examples further include, responsive to the convergent price vector, producing power for or consuming power from the power transmission network.

According to another aspect of the disclosed technology, apparatus include one or more computer-readable storage media storing computer-executable instructions that when executed by a computer, cause the computer to perform any method example described herein.

According to further aspect of the disclosed technology, apparatus include control systems configured to control power produced by a participant for, or consumed by the participant from, a power transmission network, with the control systems including one or more processors, a network adapter configured to receive a price vector and to transmit energy and ancillary service estimates to a coordinator, one or more computer-readable storage media storing computer-executable instructions that when executed by the processors, cause the controller to perform any of the methods described herein, and one or more actuators configured to activate and/or deactivate power production or consumption by the participant in response to one or more signals received from the processors.

According to another aspect of the disclosed technology, methods of allocating power by a coordinator to a plurality of participants coupled to a power transmission network and meeting ancillary service requirements for the power transmission network, include sending an iteration k price vector to the participants, wherein the iteration k price vector comprises prices for energy services and ancillary services to be produced or consumed by the participants during a plurality of time periods that form power transmission time sequence of power transmission over a power transmission network, receiving from each of the participants energy and ancillary service estimates for what each participant can produce for or consume from the power transmission network at the prices of the iteration k price vector for each of the time periods in the power transmission time sequence, and determining whether the iteration k price vector is convergent such that for each time period of the power transmission time sequence the combined energy for all participants is power balanced and the ancillary services satisfy power transmission network requirements, and if not convergent, updating the price vector for a subsequent iteration k+1 based on the estimates received from each participant. Some examples include iterating the sending, receiving, determining until a convergent price vector is obtained. Some examples include, responsive to the convergent price vector, performing the power allocation. In some examples, updating the price vector comprises modifying the iteration k price vector by a subgradient value associated with the estimates and updating a convergence parameter. In some examples, energy services and ancillary services are hierarchically decentralized between the coordinator and the participants in communication with the coordinator.

According to another aspect of the disclosed technology, coordinator control systems configured to allocate power over a power transmission network among a plurality of participants and to meet ancillary service requirements for the power transmission network, include one or more processors, a network adapter configured to transmit a price vector to the participants and to receive energy and ancillary service estimates from the participants, and one or more computer-readable storage media storing computer-executable instructions that when executed by the processors, cause the controller to perform the method any of the methods described herein.

According a further aspect of the disclosed technology, example power grids include an electric power distribution system configured to transmit electric power from one or more participants to one or more other participants, and a market coordinator configured to perform any of the methods described herein.

According to another aspect of the disclosed technology, methods include iterating a price vector between a coordinator and a plurality of participants, wherein the price vector comprises prices for energy services and ancillary services to be produced or consumed by the participants during a plurality of time periods that form power transmission time sequence of power transmission over a power transmission network, until a convergent price vector is obtained, and responsive to the convergent price vector, producing or consuming power over the power transmission network and providing ancillary services to the power transmission network during at least one of the time periods of the power transmission time sequence. In some examples, the iterating for an iteration index k includes, by each participant, receiving an iteration k price vector from the coordinator, estimating energy and ancillary services that the participant can produce for or consume from the power transmission network at the prices of the iteration k price vector for each of the time periods in the power transmission time sequence based on the iteration k price vector and characteristics of the participant, and sending the estimates to the coordinator, and, by the coordinator, determining whether the iteration k price vector is convergent such that for each time period of the power transmission time sequence the combined energy for all participants is power balanced and the ancillary services satisfy power transmission network requirements, and if not convergent, updating the price vector for a subsequent iteration k+1 based on the estimates received from each participant. In some examples, estimating energy and ancillary services for one of the time periods based on the iteration k price vector and characteristics of the participant includes selecting energy and ancillary service values from a participant iteration function. In some examples, a participant iteration function is configured to compare (i) a utility function specific to the participant, (ii) the energy amount produced for or consumed from the transmission network by the participant as constrained by a coupling of the participant to the power transmission network, and (iii) the ancillary services provided to the power transmission network by the participant, and that is subject to state, energy, and ancillary service constraints of the participant at a subsequent time period. In some examples, estimating energy and ancillary services for each of the time periods in the power transmission time sequence corresponds to constructing a price horizon extending from a selected one of the time periods of the power transmission time sequence by the number of periods in the power transmission time sequence, wherein the constructing includes selecting energy and ancillary service expected values for each time period of the price horizon from a participant iteration function. In some examples, a participant iteration function compares (i) a quadratic utility function associated with a utility function specific to the participant, (ii) the energy amount produced for or consumed from the transmission network as constrained by a coupling of the participant to the power transmission network, and (iii) the ancillary services provided to the transmission network by the participant, and that is subject to stochastic characteristics of the participant. Some examples further include iterating until a price vector associated with the price horizon becomes convergent, iterating to construct price horizons extending from each of the other time periods of the power transmission time sequence, and using the convergent energy and ancillary service expected values associated with the first time period of each of the price horizons that have become convergent to form a convergent price vector. In some examples, coupling of the participant to the power transmission network is described by a mapping of power injection into or received from the power transmission network at buses onto active power flow on branches of the power transmission network. In some examples, updating of the price vector comprises modifying the iteration k price vector by a subgradient value associated with the estimates and updating a convergence parameter. In some examples, energy and ancillary services are estimated simultaneously in relation to each other using a utility function specific to the participant and power transmission constraints of the power transmission network. In some examples, energy services and ancillary services are hierarchically decentralized between the coordinator and the plurality of participants in communication with the coordinator. In some examples, the coordinator and participants include an independent system operator (ISO) and load serving entities (LSE), a distribution system operator (DSO) and distributed generators, a campus control center and campus buildings, a local grid controller and building customers, or a residential building and internal loads. In some examples, a convergent price vector is obtained by iterating in the absence of information by the coordinator of participant specific states, utilities, and/or dynamics and in the absence of information by each participant of specific states, utilities, and/or dynamics of each other participant.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic of an example environment in which certain apparatus and methods, including a power transmission network coordinator and one or more participants, can be implemented according to the disclosed technology.

FIGS. 2A-2D are iteration schematics according to examples of the disclosed technology.

FIG. 3 is a graph of iteration convergence according to examples of the disclosed technology.

FIG. 4 is a graph of stochastic prediction horizons according to examples of the disclosed technology.

FIG. 5 is a schematic of an example computing environment in which examples of the disclosed technology can be implemented.

FIG. 6 is a schematic of a controller interface as can be used in examples of the disclosed technology.

### DETAILED DESCRIPTION

I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “evaluate,” “determine,” “send,” “transmit,” and “perform” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., non-transitory computer-readable storage media, such as one or more optical media discs, volatile memory components (such as DRAM or SRAM), or nonvolatile memory components (such as hard drives and solid state drives (SSDs))) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., non-transitory computer-readable storage media). The computer-executable instructions can be part of, for example, a dedicated software application, or a software application that is accessed or downloaded via a web browser or other software application (such as a remote computing application). Such software can be executed, for example, on a single local computer (e.g., as a process executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods can also be implemented by specialized computing hardware that is configured to perform any of the disclosed methods. For example, the disclosed methods can be implemented by an integrated circuit (e.g., an application specific integrated circuit (“ASIC”) or programmable logic device (“PLD”), such as a field programmable gate array (“FPGA”)). The integrated circuit or specialized computing hardware can be embedded in or directly coupled to an electrical device (or element) that is configured to interact with controllers and coordinators. For example, the integrated circuit can be embedded in or otherwise coupled to participants that produce or consume energy, such as a distributed energy resource (DER) (also sometimes referred in the general sense of a participant of the iterative approached described herein); a load serving entity (LSE) or distributed system operator (DSO); a power plant; a generator (e.g., a wind-based generator, solar-based generator, coal-based generator, or nuclear generator); an industrial plant; a commercial or residential building; an air-conditioning unit; heating unit; heating, ventilation, and air conditioning (“HVAC”) system; hot water heater; refrigerator; dish washer; washing machine; dryer; oven; microwave oven; pump; home lighting system; electrical charger; electric vehicle charger; home electrical system; battery energy storage system (BESS); or thermal energy storage system (TESS).

II. Introduction to the Disclosed Technology

Methods and apparatus are disclosed that implement market based control frameworks which can address co-optimization problems often faced by Independent System Operators (ISO) in day-ahead energy and ancillary service markets. For ISOs and other power network coordinators, it can be difficult to allocate power generation, demand, and reserves simultaneously over distributed energy resources (DERs) in the power network such that social welfare is maximized, supply and demand are balanced, service requirements are met, and network constraints are satisfied. Such difficulties are compounded when privacy constraints are applied to the market bidding structure. According to examples herein, privacy is preserved and methods can induce dynamic cooperation among DERs.

In representative examples, the DERs are not required to reveal their states, utility, and dynamics to the ISO or to one another. The ISO communicates its energy price and ancillary service price, and the DERs respond with their corresponding power generation or consumption levels, as well as their energy reserve levels. Iteration is performed until a convergent market clearing price is obtained for energy and ancillary services. In some examples, deterministic steps are performed to achieve the convergence that optimizes social welfare. In further examples, iterative steps are performed to achieve convergent prices based on stochastic modeling of the ISO problem, using linear-quadratic-Gaussian (LQG) agents.

Examples herein can address the co-optimization problem faced by the ISO (“ISO Problem”) in day-ahead energy and ancillary service market, i.e., how the ISO should choose an energy price and ancillary service prices as a function of both time and locations, such that the sum of utilities of all agents (participants) in the system is maximized, while maintaining the balance of supply and demand, meeting ancillary service requirements, and satisfying network constraints. In general, various power producers generate and supply power different, including by different amounts, different times, and with various other constraints. Ancillary service is typically defined in relation to the total power demanded to provide a buffer when a generator fails or forecasts are incorrect. Ancillary service can also be provided by consumers as a flexibility, such as the ability to constrain or reduce load demand with water heaters, A/C units, electric heaters, etc. Ancillary service also can be provided by producer/consumer type participants like battery storage devices (including small systems like an individual electric vehicle). In some examples, total reserve power can be about 10% of total generation capacity, though other amounts (including variable ones) are possible. Thus, in various examples, the ISO or other coordinator announces a sequence of tentative energy and ancillary service market clearing prices over time and locations, and the DERs respond back with their supply/consumption as well as ancillary service bids over time with respect to the prices. This iterative process can then continue until the price sequences converge.

Coordinators, including electricity grid operators like an ISO, typically face several challenging constraints, including that production must be simultaneous with demand, different ancillary services such as energy reserves need to meet backup and variability requirements, the costs of different generating units vary significantly, and expected and unexpected conditions on the transmission network affect the selection of which generating units should be used to serve load reliably. Traditionally, given the demand of the loads (or a forecast), the role of the ISO in the energy market, taking into account these factors, is to allocate the required power among generators such that power is reliably delivered to meet demand and the cost of generation is minimized. This security constrained unit commitment (SCUC) and economic dispatch (SCED) problem can be solved by soliciting bids (marginal cost of production curve) from each producer and then, choosing for each hour which generator should be committed to be online and the output level of the corresponding on-line generators, typically for the next 24-hour period, such that the overall cost of producing the power demanded is minimized. After the energy market is cleared, ancillary services can be cleared in another separate market via a set of separate optimizations.

However, the above model with a fixed demand is generally insufficient for modern power systems where renewable power generation is integrated in the system. When employing renewable energy, such as solar and wind which vary unpredictably with time, demand needs to be adjusted accordingly to match the availability of renewable energy. The ISO allows this additional flexibility of loads to enter the system by introducing demand bids submitted by Load Serving Entities (LSEs) during the SCUC and SCEC processes. LSEs, also known as electric utilities, secures energy and transmission service (and related Interconnect Operations Services) to serve the electrical demand and energy requirements of its end-users and wholesale customers. Similar to the dispatch problem stated above, bids from both generators and LSEs clear in a day-ahead energy market. The current day-ahead energy market lets market participants commit to buy or sell wholesale electricity one day before the operating day where SCUC and SCED are performed to satisfy energy demand bids and to ensure adequate scheduling of resources to meet the next day's anticipated load. In practice, prices resulting from clearing the bids in a day-ahead market are not identical across different locations. This is typically due to physical limits of the transmission systems such as congestions and line losses. Prices at different locations, called Locational Marginal Price (LMP), reflect the operating characteristics of and the major constraints on the transmission system at different locations as well as losses resulting from physical limits of the transmission system. LMPs are widely used for collecting transmission congestion charges and determining compensation for holders of Financial Transmission Right.

Generator and LSE bids are hourly in the current day-ahead energy market, and they are cleared hour-by-hour. This single-period formulation can create the issue of load synchronization because future flexibilities of individual loads are not taken into account in the current market clearing. As a consequence, current approaches to managing the day-ahead energy market are not sufficient for future active distribution systems with high penetration of flexible loads and renewable energy, as power generators, renewable resources, and loads are all dynamic stochastic systems with individual constraints. For example, fossil fuel generators have ramping constraints: there is a limit of increase or decrease of output level between two consecutive time intervals; PV generation in a distribution system is uncertain in nature, and its forecast may, change with weather updates. Similarly, with the presence of distributed energy resource (DER) flexibilities in distribution systems, LSEs can be modeled advantageously as dynamic systems with intertemporal constraints representing the preferences of DERs. As a non-limiting example, a residence or commercial building can exhibit various indoor air temperature dynamics with intertemporal constraints such as comfort level or temperature set point. To incorporate DER flexibilities into power market coordination, all market participants, including generators, renewable generation, and loads (e.g., LSEs with DERs) can be modeled as dynamic stochastic systems and all variables, including power output and demand, are functions of time. Market clearing prices (LMPs), on the other hand, are functions of both time and location. Further advantages are obtained with co-optimization of the energy market and the ancillary service market as ancillary service costs can be reduced and consistent pricing incentives can be provided.

As discussed above, examples herein can address the co-optimization problems faced by the ISO or other market participants in day-ahead energy and ancillary service markets. Because of the competitive nature of commercial producers and the interest in protection of consumer privacy, disclosed examples can be performed in a hierarchical decentralized manner in which the ISO or other coordinator does not know the states/utilities/dynamics of the DERs or other participants, and the DERs do not need to know states/utilities/dynamics of each other. In such examples, it becomes possible to obtain convergent market clearing price vectors where the only share of information occurs between the DERs and the ISO. In representative examples, the share of information can include the ISO announcing a sequence of tentative energy and ancillary service market clearing prices over time and locations, and the DERs responding back with their supply/consumption as well as ancillary service bids over time with respect to the prices. In selected examples, the share of information is restricted to this information. Disclosed examples iteratively continue the process of announcing and responding until the price sequences converges. Without the sharing of DER states, utilities, and dynamics information by the DERs with the ISO, the complexity of iterating on price vectors over time, as opposed to price for one time instant, increases substantially. It is worth noting that similar to the tatonnement process in general equilibrium theory, the system-level utility maximization problem faced by the ISO is conducted by DERs in a distributed manner, coupled only by the prices announced by the ISO. It is also worth noting that disclosed examples have eliminated network constraints and thus prices are identical across different locations. Thus, representative examples herein can address a complete system-wide multi-period dynamic co-optimization problem faced by the ISO with DER flexibilities and uncertainties, and can satisfy energy balancing constraints, ancillary service requirements, and network constraints. In representative deterministic examples, iterations lead to a social welfare maximum under appropriate convexity assumptions of the utility functions. In representative stochastic examples, agents (e.g., participants, DERs, etc.) can be modeled as linear Gaussian systems and the cost functions are quadratic. As shown with detailed examples below, iteration can be performed similar to deterministic examples to yield systemwide global optimums. In accordance with examples, each agent i can track its present state Xᵢ(t) without being required to track the entire history, as may be the general case with decentralized stochastic control.

Various approaches have been proposed for addressing dynamical energy pricing, but none has been able to achieve any similar results as with the disclosed examples. In particular, none of the various previously proposed approaches can achieve the co-optimizing the energy and ancillary service market over multiple time periods in a hierarchical decentralized manner, in a power network consisting of dynamic generators, renewable resources and LSEs with DERs.

III. Example Smart Grid Network

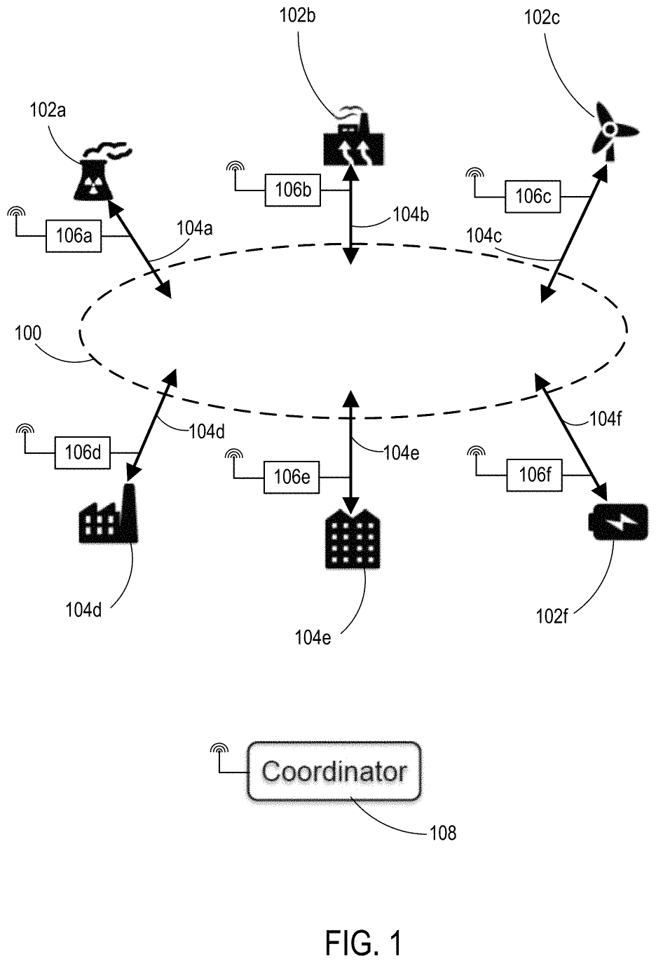

FIG. 1 shows a schematic of a smart grid 100 which couples N DERs, such as (N=6) nuclear power plant 102a, coal power plant 102b, renewable supply 102c, industrial building 102d, residential home 102e, and battery or thermal electric storage system 102f, with power transmission grid lines 104a-104f. The specific types listed for DERs 102a-102f are merely illustrative and it will be appreciated that numerous other DER examples may be used. Thus, DERs can be either producers or consumers of electricity. The DERs can have respective controllers 106a-106f coupled to control, or communicate with control circuitry of the respective DER 102a-102f that controls, or with downstream controllers or layers associated with the respective DER 102a-102f that controls, power generation or consumption of the DER on the smart grid 100. The DER controllers 106a-106f are also in network communication (e.g., wired or wireless) with a power transmission network market coordinator 108 so that iterated communications can be performed to determine convergent price vectors for energy and ancillary services.

While FIG. 1 shows schematically the smart grid 100 as a network between DER participants, with some producing energy, some consuming energy, and some both producing and consuming energy, disclosed examples can be applied to various different DER participant levels and various different resource settings. For example, an ISO can coordinate multiple LSEs (or DSOs), an LSE can coordinate multiple load aggregators, a load aggregator can coordinate multiple load participants (such as buildings, homes, etc.), a load participant can coordinator multiple devices (such as a home appliance, a lighting system, chiller, solar array, electric vehicle charger, etc.). Examples can also be nested to form multi-layer (two, three, four, etc.) frameworks. For example, an ISO can coordinate multiple DSOs, with one or more of the DSOs each in turn operating as coordinators of load aggregators, with one or more of the load aggregators each in turn operating as coordinators of load participants, with one or more of the load participants each in turn operating as coordinators of coupled devices, etc.

In disclosed examples, time is modeled as consisting of discrete periods and each period corresponds to a 1-hour interval of the day-ahead market. In other examples, other temporal intervals may be used and time sequences can include various lengths, i.e., not limited to 24 1-hour intervals. The flexibility of the various described approaches can also be applied to other problems beyond the day-ahead construct, including real-time power markets. While specific examples are described in relation to solving the problem as considered from the ISO level, with each load bus (agent) being represented by an aggregate LSE model, other coordinator/participant formats are contemplated. Examples can be used with various models, such as the virtual battery model.

In general, each agent (or participant) 102a-102f is modeled as a dynamic system. By providing such dynamic modeling, intertemporal constraints and uncertainties can be addressed, such as with generators which typically have ramping constraints, and with consumers behind each LSE which may have similar ramping constraints as well as delays in load dynamics. In examples, the state of agent i at time t, denoted as xᵢ(t), evolves as,

xᵢ(t+1)=fᵢ^{t}(xᵢ(t),uᵢ(t),rᵢ(t)), t=0,1, . . . ,T−1. (1)

where uᵢ(t) is the amount of energy (or equivalently, average interval power) each agent i supplies to or obtains from the grid 100 at time t. uᵢ(t)>0 stands for supplying energy to the grid 100 by agent i at time t, while uᵢ(t)<0 signifies an energy consumption by agent i. rᵢ(t) is the amount of ancillary service power supplied to the grid 100 at time t. A straightforward and important constraint in many examples disclosed herein is that there must be a power balance at each time over the grid 100: Σᵢ₌₁N uᵢ(t)=0 for all t. Ancillary service requirements also need to be satisfied: Σₜ₌₁^{N} rᵢ(t)=R(t) where R(t) is the ancillary service signal that needs to be followed. In addition, network constraints posed by the underlying power-flow equations through the lines 104a-104f on the grid 100 are incorporated. In the following example, a simplified direct-current (DC) power flow method is used, which gives good and fast estimations of line power flows on an AC power system, to specify the network constraints, though other examples can use other power flow estimations. A nonlinear model of the AC system can be simplified to a linear model of DC power flow if the following assumptions hold:

Line resistances (active power losses) are negligible, i.e. R«X.

Magnitudes of bus voltages are set to 1 per unit.

Voltage angle differences are small, i.e. sin(θ)≈θ and cos(θ)≈1.

Based on the above assumptions, voltage angles θᵢ are the variables to solve given active power injections Pᵢ in advance. Without loss of generality, agents are assumed to be geographically located at N different buses, which results in Pᵢ=uᵢ. Under a DC flow assumption, the active power balance equations reduce to a set of linear equations:

$${u}_{i} = {\sum }_{j = 1}^{N} {B}_{ij} ( {θ}_{i} - {θ}_{j} ) ,$$

where Bᵢⱼ is the susceptance between bus i and j, or the imaginary part of the bus admittance matrix Yᵢⱼ. As a result, active power flow through transmission line lᵢ between bus j and k can be calculated as:

$${P}_{{l}_{i}} = \frac{{θ}_{j} - {θ}_{k}}{{X}_{{l}_{i}}} ,$$

where Xₗᵢ is the reactance of line h. DC power flow equations in matrix form and the corresponding matrix relation for flows through branches.

Θ=B⁻¹U, (2)

Pₗ=DAΘ (3)

where

U:=(u₂, . . . u_{N})^{T} is the vector of bus active power injections for buses 2, . . . , N,

B∈ [symbol] ^{(N-1)×(N-1)} is a matrix whose non-diagonal elements are susceptance and diagonal element is the sum of non-diagonal elements in the same row,

θ× [symbol] ^{(N-1)×1} is the vector of bus voltage angles for buses 2, . . . , N,

Pₗ∈ [symbol] ^{M×1} is the vector of branch flows (M is the number of branches)

D∈ [symbol] ^{M×M} is a diagonal matrix with dₖₖ equal to the negative susceptance of line k,

A∈ [symbol] ^{M×(N-1)} is the bus branch incidence matrix.

Plugging (2) into (3), the following equation is obtained:

P₁=DAB⁻¹U=HU. (4)

where H:=DAB⁻¹ is a M×N−1 matrix that maps active power injection at buses onto active power flow on branches. Notably, the condition Σᵢ₌₁^{N} uᵢ=0 takes care of the issue of slack bus, since slack bus is created solely to balance the active power in the system. A natural constraint on the active power flow on transmission line is: H U≤C, where C is the vector of active power flow limits of the branches in the system. This inequality takes care of the direction of flows since |HU|≤C can be equivalently written as H′U≤C where

$${H}^{′} = [ \begin{matrix}H \\ - H\end{matrix} ] .$$

In general, line losses are not considered, assuming losses are not significant enough to impact the economics of the system operation. However, other examples can include generalized models to include these contraints.

In examples, each agent i, such as DERs 102a-102f, has a stage-wise utility function Fᵢ(xᵢ(t), uᵢ(t), rᵢ(t)), which can correspond to the amount of utility accrued during a selected time interval. For producers, this could be the negative of the cost of production. For uncontrollable load and renewable generation, Fᵢ=0 and uᵢ(t)'s can be assumed to be the forecast values. For flexible loads connected to one LSE, Fᵢ can be assumed to be the aggregate total utility of these flexible loads. The total utility of agent i over the time horizon {0, . . . , T−1} is Σₜ₊₀^{T-1}Fᵢ(xᵢ(t),uᵢ(t),rᵢ(t)). There could be constraints on input uᵢ, for model (1), such as ramp constraints |uᵢ(t+1)−uᵢ(y)|≤rᵢ. In that case, these constraints are not dualized in the sequel, but carry over to the dual. For example, local constraints imposed by individual DERs can be taken into account when the DER solves its own optimization problem based on energy and ancillary service prices announced by a coordinator. For simplicity, such constraints are not shown in the example, but can be considered in other examples.

Because commercial producers are competitive and it is desirable to protect the privacy of consumers, representative examples are hierarchical decentralized. Examples of deterministic algorithms and stochastic algorithms are derived hereinafter which satisfy information and action decentralization, with communications between ISO, such as the coordinator 108, and agents, such as the DERs 102a-102f, restricted to the ISO announcing through network communication a sequence of energy and ancillary service prices and agents responding through network communication with supply/consumption and ancillary service bids in response to the prices. In some examples, some participants can be described by simplified models or may use alternative algorithms for bidding so that iteration can commence even without each participant actively using a common iteration algorithm or example algorithms described herein.

IV. Example Deterministic Algorithm

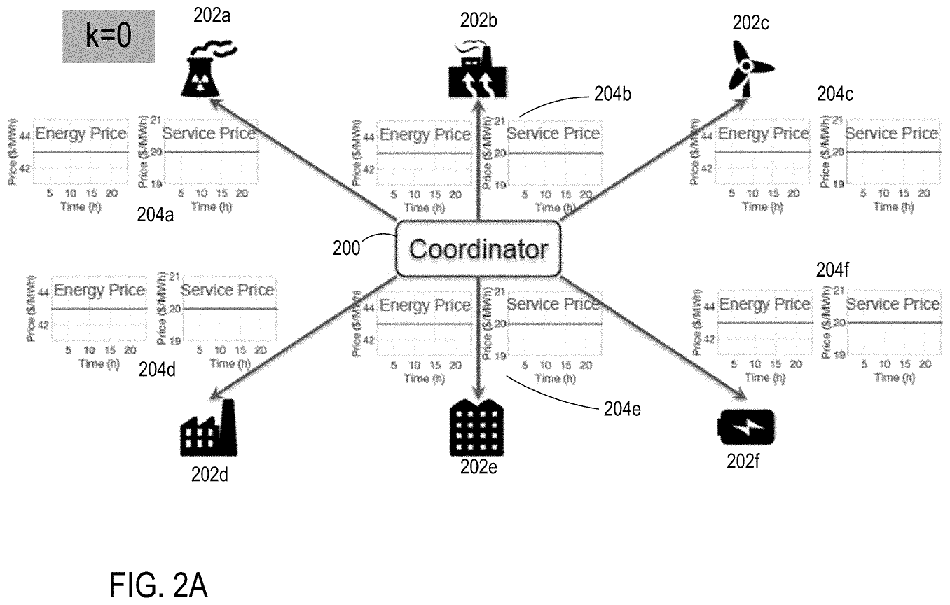

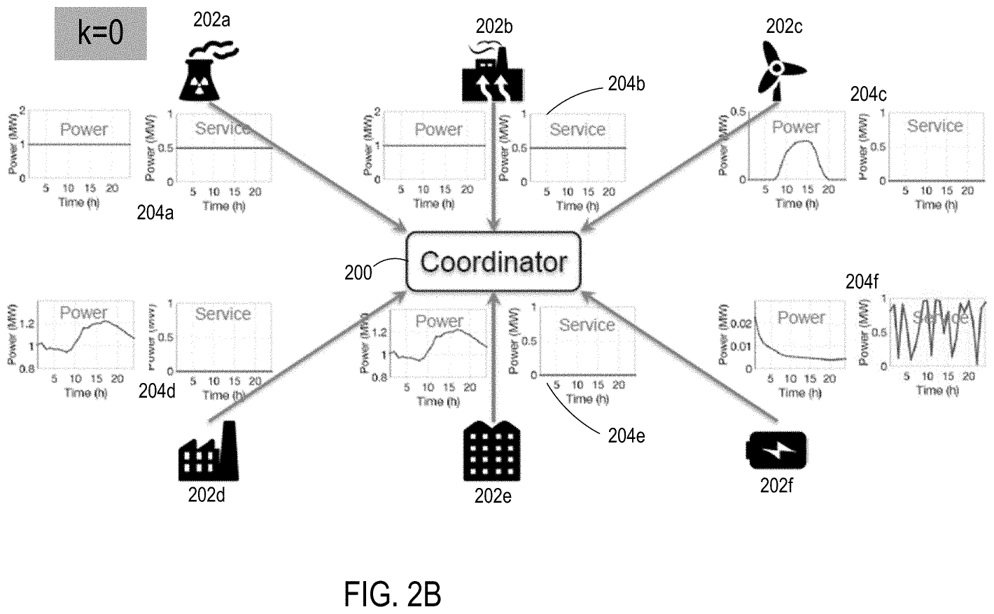

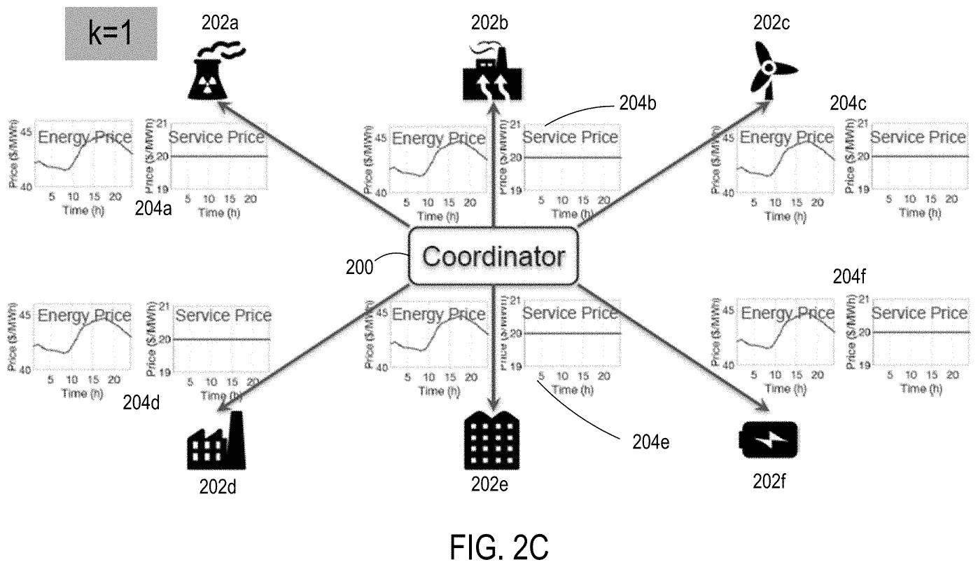

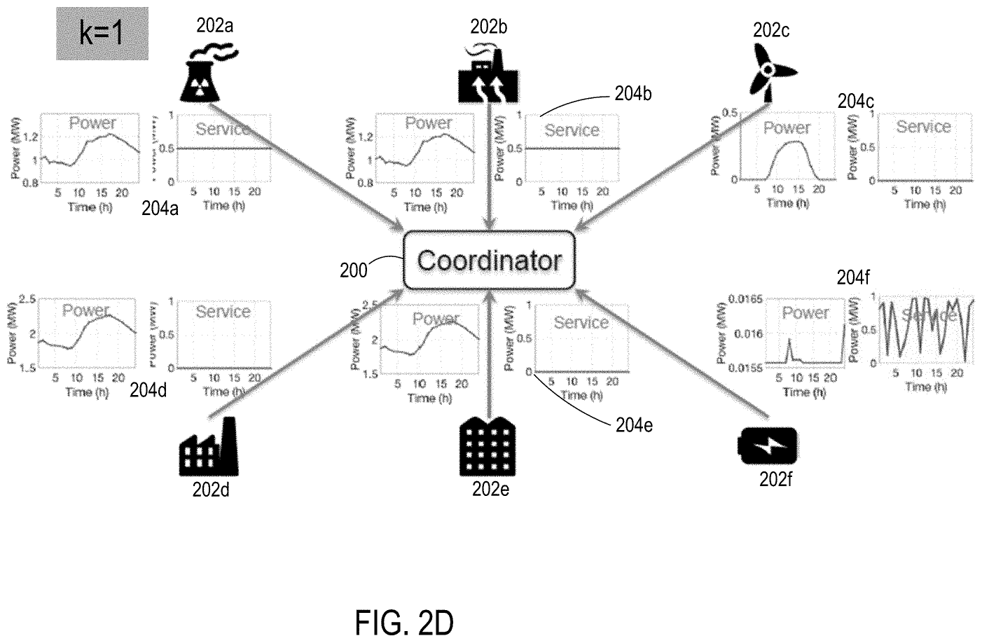

FIGS. 2A-2D schematically illustrate iterations performed according to a deterministic example, which can be used to solve a social welfare maximization problem for day ahead energy usage:

$$max {\sum }_{i = 1}^{N} {\sum }_{t = 0}^{T - 1} {F}_{i} ( {x}_{i} ( t ) , {u}_{i} ( t ) , {r}_{i} ( t ) ) subject to$$

$${\sum }_{i = 1}^{N} {u}_{i} ( t ) = 0 , ∀ t , \\ {\sum }_{i = 1}^{N} {r}_{i} ( t ) = R ( t ) , ∀ t , \\ HU ( t ) \leq C , for ∀ t , \\ {x}_{i} ( t + 1 ) = {f}_{i}^{t} ( {x}_{i} ( t ) , {u}_{i} ( t ) , {r}_{i} ( t ) ) , ∀ i , ∀ t .$$

where U (t) (u₁(t), u₂(t), . . . , u_{N} (t))^{T}. This model example can automatically takes care of renewable resources and uncontrollable loads since Fᵢ≡0 and uᵢ(t) can be taken as the prediction value over the next 24 hours.

The example deterministic energy and ancillary service co-optimization algorithm is summarized in “Algorithm 1” below. There are several choices for αₖ, and corresponding convergence results for the resulting sub-gradient method. The μ value can be the Lagrange multiplier associated with DC power flow constraints, such that when μ converges, the DC power flow constraints become satisfied.

Algorithm 1: Energy and ancillary service market co-
optimization

| k = 0; Initialize (λ_{E}, λ_{R}, μ)^{k} to some arbitrary value; | |
|---|---|
| repeat | |
| \| | Each agent i solves the problem |
| \| | ${max}_{{U}_{t} , {R}_{t}} {\sum }_{t = 0}^{T - 1} [ {F}_{i} ( {x}_{i} ( t ) , {u}_{i} ( t ) , {r}_{i} ( t ) ) +$ |
| \| | (λ_{E}^{k}(t) − [μ^{k}(t)]^{T} Hᵢ) uᵢ(t) + λ_{R}^{k}(t)rᵢ(t)], |
| \| | subject to |
| \| | xᵢ(t + 1) = fᵢ^{t} (xᵢ(t), uᵢ(t), rᵢ(t)), t = 0, . . . , T − 1. |
| \| | and submit their bids Uᵢ^{k} and Rᵢ^{k}, to the ISO. |
| \| | The ISO then updates the energy and ancillary |
| \| | service price vector, for t = 0, . . . , T − 1 |
| \| | ${λ}_{E}^{k + 1} = {λ}_{E}^{k} - {α}_{k} ( {\sum }_{i = 1}^{N} {U}_{i}^{k} ) ,$ |
| \| | μ(t)^{k+1} = max (μ(t)^{k} + αₖ (HU^{k}(t) − C), 0). |
| \| | ${λ}_{R}^{k + 1} = {λ}_{R}^{k} - {α}_{k} ( {\sum }_{i = 1}^{N} {R}_{i}^{k} - R ) ,$ |
| \| | k = k + 1. |

until (λ_{E}, λ_{R}, μ)^{k} converges to (λ_{E}, λ_{R}, μ)*;

As shown in FIG. 2A, at a first iteration k=0, for example, a coordinator 200 sends out an initial energy and ancillary service price vector to each agent 202a-202f participating in the energy and ancillary service market coordination. As k increases, the price vector for energy and ancillary services changes until the price vector converges. In representative multi-period examples, the coordinator 200 sends out 24 energy prices and 24 service prices to each agent participant. As shown in FIG. 2B, after each participant receives the price vector, each participant 202a-202f responds with the power and service profile 204a-204f specific to each participant, based on an iteration function of the participant. For example, each participant has its own cost objective or utility function, dynamics, and intertemporal constraints. The iteration function can account for the amount of energy the participant will produce or consume as constrained by its coupling of the participant to the power grid, as further constrained by state, energy, and ancillary service constraints of the participant at later time intervals. With these different operating points, based on the price vector received, each participant 202a-202f solves an internal optimization of that participant's iteration function to produce estimates for an optimal power consumption or power generation and ancillary service it will provide for the next 24 hours. In some examples, the iteration function used to produce the estimates compares (i) a utility function specific to the participant, (ii) the energy amount produced for or consumed from the transmission network by the participant as constrained by a coupling of the participant to the power transmission network, and (iii) the ancillary services provided to the power transmission network by the participant, and that is subject to state, energy, and ancillary service constraints of the participant at a subsequent time period. The participants 202a-202f then send the estimates to the coordinator 200 which will then check for convergence and update the price vector for a subsequent iteration. In some examples, the DER has information providing its utility function, dynamics, and intertemporal constraints. Such information can be provided through mathematical modeling, system identification, or other data-driven approaches. Functional characteristics can be tunable or updateable as well, based on new or refined system models or user selectable settings, by way of example. In general, user selectable settings (tradeoffs between savings and comfort, target temperature, storage capacity sharing, etc.) are parameters of utility function, dynamics, and constraints. For example, a trade-off between savings and comfort generally affects utility function while desired temperature generally affects intertemporal constraints. User settings can also relate to model characteristics and load dynamics, such as model descriptors like building size, insulation degree, energy score, ramp constraints, storage capacity, etc.

FIG. 2A shows energy and service price profiles 204a-204f that are constant over the 24 hours as an initial guess by the coordinator. In FIG. 2B these become updated after receiving the estimates from the participants, as each participant 202a-202f has different objectives and constraints. For example, a power generator such as the nuclear power plant 202a or coal power plant 202b remain relatively constant while the renewable energy source 202c or battery electric storage 202f are curved.

After receiving the power and service estimates, the coordinator 200 can then check if all supplied power is equal to demanded power, and if it does, a balanced system is obtained an optimal cleared price for the energy market is obtained. The coordinator 200 can also check that the sum of all ancillary service power provided by the participants 202a-202f is greater than or equal to a minimum ancillary service requirement. If both conditions are satisfied, the convergence is obtained for the price vector and further iterations are not required. However, typically convergence is not achieved after a single iteration. FIG. 2C shows the example process continuing to a second iteration (k=1). To produce an updated price vector, the coordinator 200 modifies the price vector based on the disparities in the estimates in relation to energy balance and the ancillary service requirements. For example, as mentioned above, a subgradient method may be used to update the price vector, using a suitable step size αₖ, such as a constant or variable step size. In general, subgradient methods are suitable for solving convex minimization problems, particularly where objective functions are non-differentiable, though other methods may be used as well such as gradient methods. The updating of the price vector also updates a μ parameter which can correspond to an iteration dependent Lagrange multiplier.

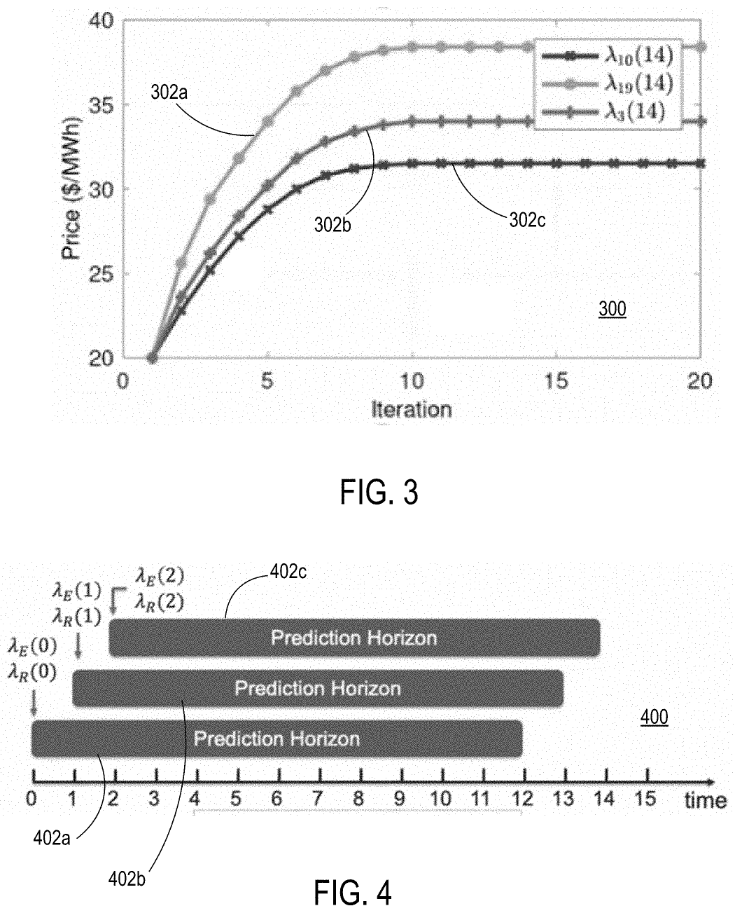

The coordinator 200 sends the updated price vector to the participants 202a-202f to begin the second iteration. As shown in FIG. 2D, the participants 202a-202f perform a similar co-optimization of the participant iteration functions using the new price vector received from the coordinator 200 and respond back to the coordinator 200, similar to the previous iteration, with respective power production/consumption and ancillary service provided for the next 24 hours. The coordinator 200 checks whether powers balance and whether service profiles meet service requirements, and if not, the process may continue to the third iteration. The process can continue until the price vector converges such that power is balanced and ancillary service requirements are met for the grid. FIG. 3 shows a graph 300 of three example iteration sequences 302a-302c performed between a coordinator and participants on a smart grid model of a campus of buildings. As shown, convergence for the price vector was obtained in about 10 iterations or fewer.

Compared with a single-period scheme, the multi-period formulations disclosed herein can achieve a higher social welfare because a single-period scheme is mathematically equivalent to a multi period formulation with additional constraints on U (t), which results in a smaller feasible set.

V. Example Stochastic Algorithm

In deterministic examples, the dynamics of the agents were assumed to be deterministic, i.e., system state at a next time instant t+1 was completely determined by the state and input at time t. However, additional advantages might be obtained by modeling with more realistic characteristics, such as by considering stochastic nature of various participants, such as renewable energy as well as consumer demands. Let ωᵢ=(ωᵢ(1), ωᵢ(2), . . . , ωᵢ(T)) be the “private” stochastic process affecting only agent i's system via:

xᵢ(t+1)=fᵢ^{t}(xᵢ(t),uᵢ(t),rᵢ(t),ωᵢ(t)),

In representative examples, the stochastic process ωᵢ is not completely observed by the other agents, and only agent i knows the law of ωᵢ. The social welfare maximization problem faced by the ISO (day ahead usage (DAU)) now becomes:

$$max 𝔼 {\sum }_{i = 1}^{N} {\sum }_{t = 0}^{T - 1} {F}_{i} ( {x}_{i} ( t ) , {u}_{i} ( t ) , {r}_{i} ( t ) ) subject to$$

$${\sum }_{i = 1}^{N} {u}_{i} ( t ) = 0 , ∀ t , \\ {\sum }_{i = 1}^{N} {r}_{i} ( t ) = R ( t ) , ∀ t , \\ HU ( t ) \leq C , ∀ t , \\ {x}_{i} ( t + 1 ) = {f}_{i}^{t} ( {x}_{i} ( t ) , {u}_{i} ( t ) , {r}_{i} ( t ) ) , ∀ t .$$

If the goal of ISO is to optimize social welfare over all decentralized policies, then the ISO needs to play a more active role in order to induce cooperation among agents: the ISO needs to know states/utility/dynamics of each individual agent i as well as the probability distribution of its privately observed process ωᵢ. Then the ISO could use dynamic programming to decide the optimal U (t) for each t, as a function of the states of the entire system. However, such methods suffer from the curse of dimensionality as N increases. An optimal hierarchical decentralized solution to the DAU problem, however, remains an open problem and Singh et al. “A theory for the economic operation of a smart grid with stochastic renewables, demand response and storage,” 54th IEEE Conference on Decision and Control (CDC), December 2015, pp. 3778-3785 (herein incorporated by reference) presents two approximation algorithms with reduced complexities.

In order to streamline approaches and at the same time maintain an iterative bidding structure, a special case of the DAU problem can be considered where all agents have linear Gaussian dynamics. The noises ωᵢ are i.i.d. Gaussian random variables with mean zero. Each agent i has a quadratic utility:

$$\begin{matrix}{F}_{i} ( {x}_{i} ( t ) , u i ( t ) , {r}_{i} ( t ) ) = {q}_{i} {x}^{2} ( t ) + {s}_{i} {u}^{2} ( t ) with {q}_{i} \leq 0 and \\ max 𝔼 {\sum }_{i = 1}^{N} {\sum }_{t = 0}^{T - 1} ( {q}_{i} {x}_{i}^{2} ( t ) + {s}_{i} {u}_{i}^{2} ( t ) ) subject to & \\ {\sum }_{i = 1}^{N} {u}_{i} ( t ) = 0 , ∀ t , & ( 5 ) \\ {\sum }_{i = 1}^{N} {r}_{i} ( t ) = R ( t ) , ∀ t , & ( 6 ) \\ HU ( t ) \leq C , ∀ t , \\ {x}_{i} ( t + 1 ) = {a}_{i} {x}_{i} ( t ) + {b}_{i} {u}_{i} ( t ) + {w}_{i} ( t ) , ∀ t . & ( 7 )\end{matrix}$$

In representative examples, the same information sharing structure as in the DA problem can be assumed: system dynamics given by (aᵢ, bᵢ) and cost functions given by (qᵢ, sᵢ) are all private to agent i and communications between ISO and agents can be restricted to ISO announcing a sequence of energy and ancillary service prices and agents returning back with supply/consumption and ancillary service bids in response to prices.

Similar to the bidding solutions of the DA problem, an iterative bidding scheme can be used for the CLQG problem. For example, at time s, an ISO first declares a price vector (λ(t)−μ^{T}(t) Hᵢ) for agent i for times t≥s. Agent i responds hack with uᵢ^{(λ,μ)} for t≥s. That is, at time s, each agent bids a vector of future supply/consumption and ancillary service amount in responses to future energy and ancillary service prices announced by the ISO, and ISO updates the prices in return, until convergence.

A significant insight to showing the existence of stochastic bidding scheme examples lies in the certainty equivalence property of unconstrained LQG systems: a stochastic control problem can be said to possess the property of certainty equivalence if the optimal policy for the stochastic control problem coincides with the optimal policy for the corresponding deterministic control problem in which the noise is absent. However, care must be taken in applying the property because certainty equivalence does not hold for the generally constrained LQG problem. Fortunately, constraints (5), (6) and (7) are both linear in Uᵢ and Rᵢ, and certainty equivalence continues to hold for LQG problems with linear constraints in U. Thus, a representative stochastic algorithm can be as follows:

Algorithm 2: Energy and ancillary service market co-
optimization with DER uncertainties

| for time s = 0 to T − 1 do | | |
|---|---|---|
| \| | k = 0; Initialize (λ_{E}, λ_{R}, μ)^{k} for t ≥ s to some | |
| \| | arbitrary value; | |
| \| | repeat | |
| \| | \| | Each agent i solves the problem |
| \| | \| | $max {\sum }_{t = s}^{T - 1} [ {q}_{i} {x}_{i}^{2} ( t ) + {r}_{i} {u}_{i}^{2} ( t ) +$ |
| \| | \| | (λ_{E}^{k}(t) − [μ^{k} (t)]^{T} Hᵢ) uᵢ(t) + λ_{R}^{k}(t)rᵢ(t)], |
| \| | \| | subject to |
| \| | \| | xᵢ(t + 1) = aᵢxᵢ(t) + bᵢuᵢ(t) + wᵢ(t), ∀t. |
| \| | \| | and submit their bids Uᵢ^{k} and Rᵢ^{k}, t ≥ s to the |
| | | ISO. |
| \| | \| | The ISO then updates the price vector |
| \| | \| | ${λ}_{E}^{k + 1} = {λ}_{E}^{k} - {α}_{k} ( {\sum }_{i = 1}^{N} {U}_{i}^{k} ) , t \geq s ,$ |
| \| | \| | μ(t)^{k+1} = max (μ(t)^{k} + αₖ(HU^{k} (t) − C), 0), |
| \| | \| | t ≥ s. |
| \| | \| | ${λ}_{R}^{k + 1} = {λ}_{R}^{k} - {α}_{k} ( {\sum }_{i = 1}^{N} {R}_{i}^{k} - R ) , t \geq s ,$ |
| \| | \| | k = k + 1. |

| | |
|---|---|
| \| | until (λ_{E}, λ_{R}, μ)^{k} converges to (λ_{E}, λ_{R}, μ)*; |
| \| | Implement Uᵢ*(s) and Rᵢ*(s) |

end

By way of contrast, deterministic examples may rely on having a perfect future prediction, such as for the next 24 hours of operation, of a resource such as generation from a renewable wind turbine. However, with such resources there is likely to be stochasticity, or random noise, like renewable or load forecast error. For example, a forecasted load for a building might be 1 MW for another four hours, but if a load in the building breaks unexpectedly, or if occupancy changes significantly there will exist an error in the prediction. With stochastic examples herein, model predictive control can be used to address such stochasticity or uncertainty. With resources treated stochastically, the energy and ancillary service market prices become stochastic as well.

A significant feature of many stochastic examples like the algorithm 2 example above is that there is an iteration of bids in response to future prices at each time s and once the price converges, the control is implemented at only the first time instant. FIG. 4 is a graph 400 that illustrates how these price values can be selected in some stochastic examples. Prediction horizons 402a-402c are generated, each beginning at a different time interval of a time sequence (here 12 hours). After generating the horizons 402a-402c, the first values of each respective horizon are selected as the prices for respective positions of a final price vector used for the time sequence from 0 to 12. For clarity, only the first three time sequence positions are shown in FIG. 4, corresponding to energy and ancillary service prices for time intervals 0 to 1, 1 to 2, and 2 to 3. While the example above is shown for a 12 hour sequence duration, in typical day ahead examples, the time sequence is 24 hours. The sequences can also be updated in different ways from a typical day-ahead arrangement, such as real-time or more frequently than daily.

Examples of the disclosed technology formulate the co-optimization problem of allocating power supply/demand and reserves simultaneously over heterogeneous energy producing or consuming agents, connect to a smart-grid in a dynamic fashion with network flow constraints, including under deterministic setting and/or stochastic settings. Two hierarchical decentralized iterative algorithmic groups are disclosed to solve the deterministic version and stochastic version of the problem. Under concavity assumptions, examples according to algorithm 1 achieve the global maximum of social welfare in the absence of noise. In the presence of noise, examples according to algorithm 2 achieve optimality if agents have linear dynamics and quadratic costs.

VI. Example Computing Environment

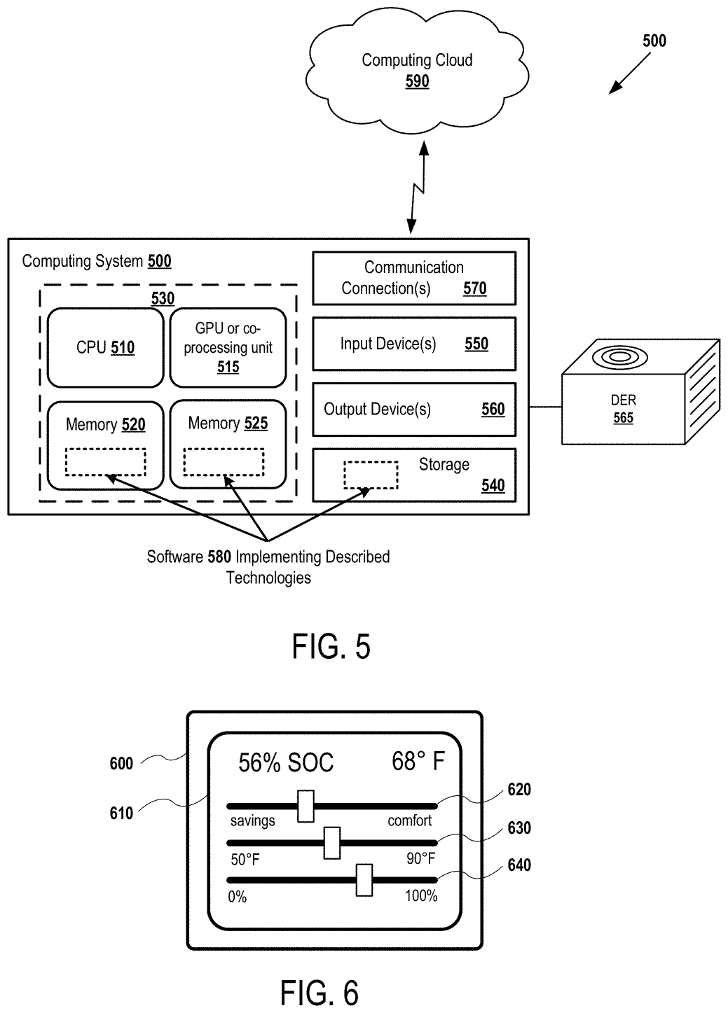

FIG. 5 illustrates a generalized example of a suitable computing environment 500 in which described embodiments, techniques, and technologies, can be implemented, including estimating energy and ancillary service levels by a smart grid participant, and providing and updating price vectors by a coordinator. For example, the computing environment 500 can implement any of the DER controllers and/or or market coordinators as described herein.

The computing environment 500 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 5, the computing environment 500 includes at least one central processing unit 510 and memory 520. In FIG. 5, this most basic configuration 530 is included within a dashed line. The central processing unit 510 executes computer-executable instructions and may be a real or a virtual processor. In a multi-processing system, multiple processing units execute computer-executable instructions to increase processing power and as such, multiple processors can be running simultaneously. The memory 520 may be volatile memory (e.g., registers, cache, RAM), non-volatile memory (e.g., ROM, EEPROM, flash memory, etc.), or some combination of the two. The memory 520 stores software 580, images, and video that can, for example, implement the technologies described herein. A computing environment may have additional features. For example, the computing environment 500 includes storage 540, one or more input devices 550, one or more output devices 560, and one or more communication connections 570. An interconnection mechanism (not shown) such as a bus, a controller, or a network, interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which can be used to store information and that can be accessed within the computing environment 500. The storage 540 stores instructions for the software 580, plugin data, and messages, which can be used to implement technologies described herein.

The input device(s) 550 may be a touch input device, such as a keyboard, keypad, mouse, touch screen display, pen, or trackball, a voice input device, a scanning device, or another device, that provides input to the computing environment 500. For audio, the input device(s) 550 may be a sound card or similar device that accepts audio input in analog or digital form, or a CD-ROM reader that provides audio samples to the computing environment 500. The input device(s) 550 can also include sensors and other suitable transducers for generating data about the environment such as room temperature, humidity, and status information for one or more DERs (e.g., DER 565). The output device(s) 560 may be a display, printer, speaker, CD-writer, or another device that provides output from the computing environment 500. The output device(s) 560 can also include interface circuitry for sending actuating commands to the DERs, (e.g., DER 565), for example, to activate or deactivate actuators (e.g., motors, solenoids, hydraulic actuators, pneumatic actuators, relays, contactors, etc.) the DER, or to request sensor or other data from the DER.

The communication connection(s) 570 enable communication over a communication medium (e.g., a connecting network) to another computing entity. The communication medium conveys information such as computer-executable instructions, compressed graphics information, video, or other data in a modulated data signal. The communication connection(s) 570 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed controllers and coordinators. Both wired and wireless connections can be implemented using a network adapter. In a virtual host environment, the communication(s) connections can be a virtualized network connection provided by the virtual host. In some examples, the communication connection(s) 570 are used to supplement, or in lieu of, the input device(s) 550 and/or output device(s) 560 in order to communicate with the DERs and/or sensors.

Some embodiments of the disclosed methods can be performed using computer-executable instructions implementing all or a portion of the disclosed technology in a computing cloud 590. For example, data acquisition and DER actuation can be performed in the computing environment while computing energy and ancillary service estimates, price vectors, and/or related iterations, can be performed on servers located in the computing cloud 590.

Computer-readable media are any available media that can be accessed within a computing environment 500. By way of example, and not limitation, with the computing environment 500, computer-readable media include memory 520 and/or storage 540. As should be readily understood, the term computer-readable storage media includes the media for data storage such as memory 520 and storage 540, and not transmission media such as modulated data signals.

VII. Example Consumer Controller

FIG. 6 depicts a controller 600 including a touch screen display 610 as can be used to control energy loads, supply, and/or ancillary services associated with a residence or other facility. As shown, the controller 600 includes user preference controls, including a user preference control 620, which allows a user to weight energy savings versus comfort, and a temperature control 630, which can be used to indicate a desired room air temperature. Some examples can include a battery or thermal energy storage control, e.g., to select a target state of charge or to select a degree of participation in consuming and supplying power and/or ancillary service as a participant in coupled smart grid network. Data input using such user controls can be used in generating energy and ancillary service energy models and related estimates, for example, models that describe the deterministic and/or stochastic dynamics of energy production and consumption of loads coupled to the controller 600. In general, user controls can provide a user with the ability to specify its preferences which become reflected in a utility function or dynamics compiled by the controller 600. In some examples, the controller includes hardware for actuating various loads, while in other examples, the controller sends signals to other hardware in order to actuate associated loads. In some examples, each load is associated with a single controller, while in other examples, a single controller is used to generate model characteristics and energy and ancillary service estimates for two or more loads. In some examples of the disclosed technology, both the response and bidding processes are automatically executed by a programmable controller (e.g., controller 300). The user can slide the control bars to indicate user preferences, which is reflected in the energy response used to calculate bids.

In view of the many possible embodiments to which the principles of the disclosed subject matter may be applied, it should be recognized that the illustrated embodiments are only preferred examples and should not be taken as limiting the scope of the scope of the claims to those preferred examples. Rather, the scope of the claimed subject matter is defined by the following claims. We therefore claim as our invention all that comes within the scope of these claims.

We claim:

1. A method of producing or consuming power by a participant coupled to a power transmission network by establishing a price vector with a coordinator, comprising:
estimating energy and ancillary services that the participant can produce for or consume from the power transmission network for each time period in a power transmission time sequence at prices of an iteration k price vector based on the iteration k price vector and states, utilities, and dynamics of the participant; and
sending the estimates to the coordinator.

2. The method of claim 1, further comprising, responsive to sending the estimates, receiving an updated price vector from the coordinator for a subsequent iteration k+1, wherein the updated price vector is produced based on the estimates sent to the coordinator and estimates received by the coordinator from each other participant coupled to the power transmission network.

3. The method of claim 2, further comprising iterating the estimating, sending, and receiving until the price vector becomes a convergent price vector such that for each time period of the power transmission time sequence a combined energy for all participants is balanced and the ancillary services satisfy power transmission network requirements.

4. The method of claim 3, wherein the estimating energy and ancillary services for one of the time periods is based on the iteration k price vector and states, utilities, and dynamics of the participant includes selecting energy and ancillary service values from a participant iteration function.

5. The method of claim 4, wherein the participant iteration function compares (i) a utility function specific to the participant, (ii) the energy amount produced for or consumed from the transmission network by the participant as constrained by a coupling of the participant to the power transmission network, and (iii) the ancillary services provided to the power transmission network by the participant, and that is subject to state, energy, and ancillary service constraints of the participant at a subsequent time period.

6. The method of claim 3, wherein the estimating energy and ancillary services for each of the time periods in the power transmission time sequence corresponds to constructing a price horizon extending from a selected one of the time periods of the power transmission time sequence by the number of periods in the power transmission time sequence, wherein the constructing includes selecting energy and ancillary service expected values for each time period of the price horizon from a participant iteration function.

7. The method of claim 6, wherein the participant iteration function compares (i) a quadratic utility function associated with a utility function specific to the participant, (ii) the energy amount produced for or consumed from the transmission network as constrained by a coupling of the participant to the power transmission network, and (iii) the ancillary services provided to the transmission network by the participant, and that is subject to stochastic characteristics of the participant.

8. The method of claim 6, further comprising:
iterating the estimating, sending, and receiving until the price vector associated with the price horizon becomes convergent;
iterating the estimating, sending, and receiving to construct price horizons extending from each of the other time periods of the power transmission time sequence; and
using the convergent energy and ancillary service expected values associated with the first time period of each of the price horizons that have become convergent to form the convergent price vector.

9. The method of claim 5, wherein the coupling of the participant to the power transmission network is described by a mapping of power injection into or received from the power transmission network at buses onto active power flow on branches of the power transmission network.

10. The method of claim 2, wherein the updated price vector comprises the iteration k price vector modified by a subgradient value associated with the estimates and with an updated convergence parameter.

11. The method of claim 2, wherein the energy and ancillary services are estimated simultaneously in relation to each other using a utility function specific to the participant and power transmission constraints of the power transmission network.

12. The method of claim 1, wherein the energy services and ancillary services are hierarchically decentralized between the coordinator, the participant, and other participants in communication with the coordinator.

13. The method of claim 1, wherein the coordinator and participants include an independent system operator (ISO) and load serving entities (LSE), a distribution system operator (DSO) and distributed generators, a campus control center and campus buildings, a local grid controller and building customers, or a residential building and internal loads.

14. The method of claim 3, wherein the convergent price vector is obtained by the iterating in the absence of information by the coordinator of participant specific states, utilities, and/or dynamics and in the absence of information by each participant of specific states, utilities, and/or dynamics of each other participant.

15. The method of claim 3, further comprising, responsive to the convergent price vector, producing power for or consuming power from the power transmission network.

16. One or more computer-readable storage media storing computer-executable instructions that when executed by a computer, cause the computer to perform the method of claim 1.

17. A control system, configured to control power produced by a participant for, or consumed by the participant from, a power transmission network, comprising:
one or more processors;
a network adapter configured to receive a price vector and to transmit energy and ancillary service estimates to a coordinator;
one or more computer-readable storage media storing computer-executable instructions that when executed by the processors, cause the controller to perform the method of claim 1; and
one or more actuators configured to activate and/or deactivate power production or consumption by the participant in response to one or more signals received from the processors.

18. A method of allocating power by a coordinator to a plurality of participants coupled to a power transmission network and meeting ancillary service requirements for the power transmission network, comprising:
sending an iteration k price vector to the participants, wherein the iteration k price vector comprises prices for energy services and ancillary services to be produced or consumed by the participants during a plurality of time periods that form power transmission time sequence of power transmission over a power transmission network;
receiving from each of the participants energy and ancillary service estimates for what each participant can produce for or consume from the power transmission network at the prices of the iteration k price vector for each of the time periods in the power transmission time sequence; and
determining whether the iteration k price vector is convergent such that for each time period of the power transmission time sequence a combined energy for all participants is power balanced and the ancillary services satisfy power transmission network requirements, and if not convergent, updating the price vector for a subsequent iteration k+1 based on the estimates received from each participant.

19. The method of claim 18, further comprising iterating the sending, receiving, determining until a convergent price vector is obtained.

20. The method of claim 19, further comprising, responsive to the convergent price vector, performing the power allocation.

21. The method of claim 18, wherein the updating the price vector comprises modifying the iteration k price vector by a subgradient value associated with the estimates and updating a convergence parameter.

22. The method of claim 18, wherein the energy services and ancillary services are hierarchically decentralized between the coordinator and the participants in communication with the coordinator.

23. One or more computer-readable storage media storing computer-executable instructions that when executed by a computer, cause the computer to perform the method of claim 18.

24. A coordinator control system, configured to allocate power over a power transmission network among a plurality of participants and to meet ancillary service requirements for the power transmission network, comprising:
one or more processors;
a network adapter configured to transmit a price vector to the participants and to receive energy and ancillary service estimates from the participants; and
one or more computer-readable storage media storing computer-executable instructions that when executed by the processors, cause the controller to perform the method of claim 18.

25. A power grid, comprising:
an electric power distribution system configured to transmit electric power from one or more participants to one or more other participants; and
a market coordinator configured to perform the method of claim 18.

26. A method, comprising:
iterating a price vector between a coordinator and a plurality of participants, wherein the price vector comprises prices for energy services and ancillary services to be produced or consumed by the participants during a plurality of time periods that form power transmission time sequence of power transmission over a power transmission network, until a convergent price vector is obtained; and
responsive to the convergent price vector, producing or consuming power over the power transmission network and providing ancillary services to the power transmission network during at least one of the time periods of the power transmission time sequence.

27. The method of claim 26, wherein the iterating for an iteration index k includes:
by each participant, receiving an iteration k price vector from the coordinator, estimating energy and ancillary services that the participant can produce for or consume from the power transmission network at the prices of the iteration k price vector for each of the time periods in the power transmission time sequence based on the iteration k price vector and characteristics of the participant, and sending the estimates to the coordinator; and
by the coordinator, determining whether the iteration k price vector is convergent such that for each time period of the power transmission time sequence the combined energy for all participants is power balanced and the ancillary services satisfy power transmission network requirements, and if not convergent, updating the price vector for a subsequent iteration k+1 based on the estimates received from each participant.

28. The method of claim 27, wherein the estimating energy and ancillary services for one of the time periods based on the iteration k price vector and characteristics of the participant includes selecting energy and ancillary service values from a participant iteration function.

29. The method of claim 28, wherein the participant iteration function is configured to compare (i) a utility function specific to the participant, (ii) the energy amount produced for or consumed from the transmission network by the participant as constrained by a coupling of the participant to the power transmission network, and (iii) the ancillary services provided to the power transmission network by the participant, and that is subject to state, energy, and ancillary service constraints of the participant at a subsequent time period.

30. The method of claim 27, wherein the estimating energy and ancillary services for each of the time periods in the power transmission time sequence corresponds to constructing a price horizon extending from a selected one of the time periods of the power transmission time sequence by the number of periods in the power transmission time sequence, wherein the constructing includes selecting energy and ancillary service expected values for each time period of the price horizon from a participant iteration function.

31. The method of claim 30, wherein the participant iteration function compares (i) a quadratic utility function associated with a utility function specific to the participant, (ii) the energy amount produced for or consumed from the transmission network as constrained by a coupling of the participant to the power transmission network, and (iii) the ancillary services provided to the transmission network by the participant, and that is subject to stochastic characteristics of the participant.

32. The method of claim 30, further comprising:
iterating the steps of claim 27 until the price vector associated with the price horizon becomes convergent;
iterating the steps of claim 27 to construct price horizons extending from each of the other time periods of the power transmission time sequence; and
using the convergent energy and ancillary service expected values associated with the first time period of each of the price horizons that have become convergent to form the convergent price vector.

33. The method of claim 29, wherein the coupling of the participant to the power transmission network is described by a mapping of power injection into or received from the power transmission network at buses onto active power flow on branches of the power transmission network.

34. The method of claim 27, wherein the updating the price vector comprises modifying the iteration k price vector by a subgradient value associated with the estimates and updating a convergence parameter.

35. The method of claim 27, wherein the energy and ancillary services are estimated simultaneously in relation to each other using a utility function specific to the participant and power transmission constraints of the power transmission network.

36. The method of claim 26, wherein the energy services and ancillary services are hierarchically decentralized between the coordinator and the plurality of participants in communication with the coordinator.

37. The method of claim 26, wherein the coordinator and participants include an independent system operator (ISO) and load serving entities (LSE), a distribution system operator (DSO) and distributed generators, a campus control center and campus buildings, a local grid controller and building customers, or a residential building and internal loads.

38. The method of claim 26, wherein the convergent price vector is obtained by the iterating in the absence of information by the coordinator of participant specific states, utilities, and/or dynamics and in the absence of information by each participant of specific states, utilities, and/or dynamics of each other participant.

39. One or more computer-readable storage media storing computer-executable instructions that when executed by a computer, cause the computer to perform the method of claim 26.

40. The method of claim 7, wherein the coupling of the participant to the power transmission network is described by a mapping of power injection into or received from the power transmission network at buses onto active power flow on branches of the power transmission network.

41. The method of claim 31, wherein the coupling of the participant to the power transmission network is described by a mapping of power injection into or received from the power transmission network at buses onto active power flow on branches of the power transmission network.
